(19) United States
(12) Patent Application Publication
(10) Pub. No.: US 2003/0194304 A1
(43) Pub. Date: Oct. 16, 2003

(54) Device for loading and unloading a load relative to a bed of a truck

(76) Inventors: Kevin Davis, Monroe, WI (US); Donald Gerber, Monroe, WI (US); Rodney Lacombe, Monroe, WI (US)

Correspondence Address: DAVID J. ARCHER, 9790 FOREST PRESERVE RD., DURAND, IL, 61024, US

(21) Appl. No.: 10/123,356

(22) Filed: Apr. 16, 2002

(51) Int. Cl. B60P 1/34

(52) U.S. Cl. 414/498

(57) ABSTRACT

A loading device is disclosed for loading and unloading a load relative to a horizontally disposed bed of a truck. The device includes a gliding arrangement secured to a first end of the load, the gliding arrangement engaging a rear end of the bed of the truck when the truck is reversed towards the gliding arrangement. A leg is secured to a second end of the load such that the load is disposed substantially between the gliding arrangement and the leg. A lifting mechanism is secured to the leg for selectively lifting and lowering the leg. Additionally, a support is pivotally secured to the load between the gliding arrangement and the leg. The arrangement is such that in a first disposition of the device, the lifting mechanism is adjusted to a lifted mode so that the leg is lifted such that the second end of the load is disposed higher than the first end of the load. The truck is then reversed towards the gliding arrangement such that the gliding arrangement engages the rear end of the bed of the truck. In a second disposition of the device, when the truck is further reversed towards the second end of the load, the support pivots towards the load due to contact of the support with the truck. In a third disposition of the device, when the truck has been yet further reversed so that the load is disposed above the bed of the truck, the lifting mechanism is adjusted to a lowered mode such that the second end of the load is supported on the bed of the truck.

### BACKGROUND OF THE INVENTION

1. Field of the Invention

The present invention relates to a device for loading and unloading a load relative to a bed of a truck.

More specifically, the present invention relates to a device for loading and unloading a load relative to a fixed bed of a truck.

2. Background Information

Heavy equipment such as road sanders and containers for liquid road deicing materials require frequent loading onto and unloading from a truck. Typically, the equipment or load is provided with pairs of front and rear legs for supporting the load when not being disposed within the truck body. Additionally, the load is provided with rollers at the front end thereof such that when a truck is reversed towards the load, with the truck body slightly elevated, the rollers engage the floor of the truck body. As the truck continues to reverse, the front supporting legs fold backwards on contact with the truck body. Further reversing of the truck causes the rollers to roll along the bed or floor of the truck until only the pair of rear legs remain outside the rear of the truck body. The track body is then lowered so that the entire weight of the load is supported on the floor of the truck body and the rear legs become slightly lifted from contact with the road surface. The rear legs are then folded for transportation of the load.

When the equipment is to be unloaded, the rear legs are unfolded and locked in position. The truck body is then slightly raised so that the rear legs contact the road surface such that the rear end of the load is slightly raised from the truck floor while the front end of the load is slidably supported on the truck body floor by the rollers. As the truck is slowly moved forward, the front legs unfold by gravity to a vertical load supporting disposition. The operator then locks the front legs in the vertical load supporting disposition. When the truck is moved further forward, the rollers disengage from the rear end of the truck body floor and the load is supported by the front and rear pairs of legs.

However, a problem exists in that many trucks are not provided with the relatively expensive equipment required to raise and lower a truck body. Particularly, with smaller trucks, such trucks are provided with a fixed generally horizontally disposed truck body floor or bed. Consequently, the aforementioned arrangement for rapidly loading and unloading equipment is not available on such fixed truck floor vehicles.

The present invention provides a unique and relatively inexpensive means for loading and unloading equipment such as road sanders, deicing equipment and tool boxes to and from a fixed generally horizontally extending truck body floor including a fixed flatbed truck body.

Therefore, it is a primary feature of the present invention to provide a device for loading and unloading a load relative to a bed of a truck that overcomes the problems associated with the prior art arrangements.

Another feature of the present invention is the provision of a device for loading and unloading a load relative to a fixed bed of a truck that is relatively easy to manufacture.

A further feature of the present invention is the provision of a device for loading and unloading a load relative to a fixed bed of a truck that is of relatively low cost.

Other features and advantages of the present invention will be readily apparent to those skilled in the art by a consideration of the detailed description of a preferred embodiment of the present invention contained herein.

### SUMMARY OF THE INVENTION

The present invention relates to a loading device for loading and unloading a load relative to a horizontally disposed bed of a truck. The device includes a gliding arrangement secured to a first end of the load. The gliding arrangement engages a rear end of the bed of the truck when the truck is reversed towards the gliding arrangement. A leg is secured to a second end of the load such that the load is disposed substantially between the gliding arrangement and the leg. A lifting mechanism is secured to the leg for selectively lifting and lowering the leg. Additionally, a support is pivotally secured to the load between the gliding arrangement and the leg. The arrangement is such that in a first disposition of the device, the lifting mechanism is adjusted to a lifted mode so that the leg is lifted such that the second end of the load is disposed higher than the first end of the load. The truck is then reversed towards the gliding arrangement such that the gliding arrangement engages the rear end of the bed of the truck. In a second disposition of the device, when the truck is further reversed towards the second end of the load, the support pivots towards the load due to contact of the support with the truck. In a third disposition of the device, when the truck has been yet further reversed so that the load is disposed above the bed of the truck, the lifting mechanism is adjusted to a lowered mode such that the second end of the load is supported on the bed of the truck.

In a more specific embodiment of the present invention, the gliding arrangement includes a roller rotatably connected to the first end of the load.

More particularly, the gliding arrangement includes a shaft having a first and a second extremity. The extremities of the shaft are bearingly supported by the first end of the load and the roller is rotatably supported by the shaft.

Furthermore, the leg includes a transverse member having a first and a second termination. The transverse member is rigidly secured to the second end of the load. A first strut has a first and a second extremity, the first extremity of the first strut being connected to the first termination of the transverse member. Also, a second strut has a first and a second end, the first end of the second strut being connected to the second termination of the transverse member.

Moreover, the first strut includes a first portion which is secured to the first termination of the transverse member and a second portion which is slidably connected to the first portion. A locking mechanism is provided for locking the portions together such that adjustment of a distance between the first and second extremities of the first strut is permitted.

Additionally, the second strut includes a first arm which is secured to the second termination of the transverse member and a second arm which is slidably connected to the first arm. A fastening mechanism is provided for fastening the arms together such that adjustment of a space between the first and second ends of the second strut is permitted.

More particularly, the first extremity of the first strut is rotatably secured to the first termination of the transverse member. Also, the first end of the second strut is rotatably secured to the second termination of the transverse member. An anchor is included for selectively anchoring the first strut in an operative disposition thereof and in an inoperative disposition thereof. A further anchor is provided for selectively anchoring the second strut in an operative disposition thereof and in an inoperative disposition thereof.

Additionally, the lifting mechanism includes a jack. In a first embodiment of the present invention, the jack includes a rotatable rod and a member threadably cooperating with the rod such that when the rod is rotated, the lifting mechanism is moved between the lifted mode and the lowered mode.

In a second embodiment of the present invention, the jack is hydraulically operated.

In a third embodiment of the present invention, the jack is electrically operated.

In a fourth embodiment of the present invention, the jack is pneumatically operated.

In a preferred embodiment of the present invention, the lifting mechanism includes a first jack which is rotatably secured to the second portion. A pin is provided for selectively locking the first jack in an operative disposition thereof and for locking the first jack in an inoperative disposition thereof. A second jack is rotatably secured to the second arm and a her pin is included for selectively locking the second jack in an operative disposition thereof and for locking the second jack in an inoperative disposition thereof.

The support includes a first brace which is pivotally connected to a first side of the load. The support also includes a second brace which is pivotally connected to a second side of the load.

More specifically, the first brace includes a first member having a first and a second end, the first end being pivotally connected to the first side of the load. A second member has a first and a second extremity. The first extremity of the second member slidably cooperates with the second end of the first member. A lock is provided for adjustably locking the first member relative to the second member. A further lock is included for locking the first end of the first member relative to the load when the load is to be supported in an absence of the truck.

Furthermore, the second brace includes a third member which has a first and a second end. The first end is pivotally connected to the second side of the load. Also, a fourth member has a first and a second extremity. The first extremity of the fourth member slidably cooperates with the second end of the third member. A locking device is provided for adjustably locking the third member relative to the fourth member. A further locking device is included for locking the first end of the third member relative to the load when the load is to be supported in the absence of the truck.

In a further embodiment of the present invention, the further lock is a self locking lock such that during an unloading operation, when the truck is driven forward with the lifting mechanism disposed in the lifted mode and when the gliding arrangement glides along the bed of the truck body towards the rear end thereof and when the first brace pivots to a load supporting disposition thereof, the further lock automatically locks so that in the absence of the truck, the load is supported by the first brace and the leg.

Similarly, the further locking device is a self locking lock such that during the unloading operation, when the truck is driven forward with the lifting mechanism disposed in the lifted mode and when the gliding arrangement glides along the bed of the truck body towards the rear end thereof and when the second brace pivots to a load supporting disposition thereof, the further locking device automatically locks so that in the absence of the truck, the load is supported by the second brace and the leg.

In one embodiment of the present invention, the first and second brace pivot between a stowed disposition and a load supporting disposition thereof by gravity.

In another embodiment of the present invention, a drive is provided for pivoting the first and second brace such that the first and second brace are pivotally driven by the drive between a stowed disposition and a supporting disposition thereof.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a side elevational view of a prior art loading arrangement for a truck having a hoistable truck body;

FIG. 2 is a similar view to that shown in FIG. 1 but shows the truck body raised;

FIG. 3 is a similar view to that shown in FIG. 2 but shows the truck being reversed towards the load;

FIG. 4 is a similar view to that shown in FIG. 3 but shows the rollers engaging the rear end of the floor of the raised truck body and the front legs beginning to fold;

FIG. 5 is a similar view to that shown in FIG. 4 but shows the front legs folded and the rear end of the load still being supported by the rear legs;

FIG. 6 is a similar view to that shown in FIG. 5 but shows the truck body lowered so that the weight of the load is being completely supported on the truck floor and the rear legs coming out of contact with the road surface;

FIG. 7 is a side elevational view of a device according to the present invention for loading and unloading a load onto a truck body having a fixed non hoistable floor;

FIG. 8 is a similar view to that shown in FIG. 7 but shows the device according to the present invention with the gliding arrangement having engaged the rear end of the fixed floor or bed of the truck body;

FIG. 9 is a similar view to that shown in FIG. 8 but shows the device according to the present invention rolling along the floor or bed of the truck with the support folding;

FIG. 10 is a similar view to that shown in FIG. 9 but shows the support folded and the load disposed above the bed of the truck but with the rear end of he load still supported by the leg;

FIG. 11 is a similar view to that shown in FIG. 10 but shows the lifting mechanism in the lowered mode so that the entire weight of the load is supported on and by the bed of the truck body;

FIG. 12 is an enlarged view taken on the line 12-12 of FIG. 7;

FIG. 13 is an enlarged view taken on the line 13-13 of FIG. 7;

FIG. 14 is a view taken on the line 14-14 of FIG. 13;

FIG. 15 is a view taken on the line 15-15 of FIG. 13;

FIG. 16 is a similar view to that shown in FIG. 14 but shows the first strut rotated to an inoperative disposition thereof;

FIG. 17 is a similar view to that shown in FIG. 15 but shows the second strut rotated to an inoperative disposition thereof;

FIG. 18 shows a second embodiment of the present invention in which the jack is hydraulically operated;

FIG. 19 shows a third embodiment of the present invention in which the jack is electrically operated;

FIG. 20 shows a fourth embodiment of the present invention in which the jack is pneumatically operated;

FIG. 21 is a side elevational view of the support shown in FIG. 7;

FIG. 22 is a view of the support 30 shown in FIG. 7 but viewed from the opposite side;

FIG. 23 is a view of a further embodiment of the present invention in which the further lock is a self locking lock;

FIG. 24 is a view of the further embodiment shown in FIG. 23 but viewed from the opposite side; and

FIG. 25 shows another embodiment of the present invention having a drive for driving the support.

Similar reference characters refer to similar parts throughout the various embodiments and views of the drawings.

### DETAILED DESCRIPTION OF THE DRAWINGS

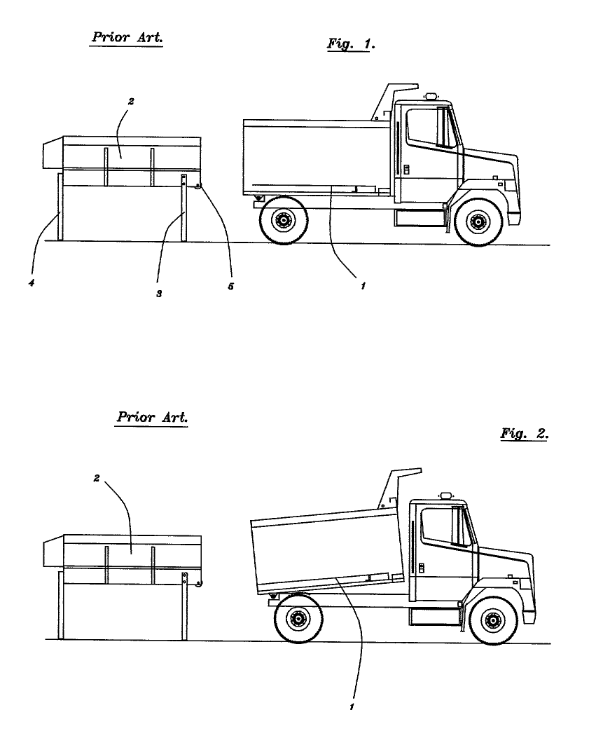

FIG. 1 is a side elevational view of a prior art loading arrangement for a truck having a hoistable truck body floor 1. As shown in FIG. 1, heavy equipment such as a road sander 2 is to be loaded onto the hoistable truck body floor 1. The sander or load 2 is provided with pairs of front and rear legs 3 and 4 respectively for supporting the load 2 when not being disposed within the truck body. Additionally, the load 2 is provided with rollers 5 at the front end thereof such that when the truck is reversed towards the load 2, with the truck body floor 1 slightly elevated, the rollers 5 engage the floor 1 of the truck body. As the truck continues to reverse, the front supporting legs 3 fold backward on contact with the truck body. Further reversing of the truck causes the rollers 5 to roll along the bed or floor I of the truck body until only the pair of rear legs 4 remain outside the rear of the truck body. The truck body floor 1 is then lowered so that the entire weight of the load 2 is supported on the floor 1 of the truck body and the rear legs 4 become slightly lifted from contact with the road surface. The rear legs 4 are then folded for transportation of the load 2.

When the equipment 2 is to be unloaded, the rear legs 4 are unfolded and locked in position. The truck body floor 1 is then slightly raised so that the rear legs 4 contact the road surface such that the rear end of the load 2 is slightly raised from the truck floor 1 while the front end of the load 2 is slidably supported on the truck body floor 1 by the rollers 5. As the truck is slowly moved forward, the front legs 3 unfold by gravity to a vertical supporting disposition. The operator then locks the front legs 3 in the vertical load supporting disposition. When the truck is moved further forward, the rollers 5 disengage from the rear end of the truck body floor 1 and the load 2 is supported by the front and rear pairs of legs 3 and 4 respectively.

FIGS. 1 to 6 illustrate the aforementioned prior art sequence for loading the load 2 onto the hoistable floor 1 of a truck. As shown in FIG. 1, the load 2 is supported by the front and the rear pairs of legs 3 and 4 respectively.

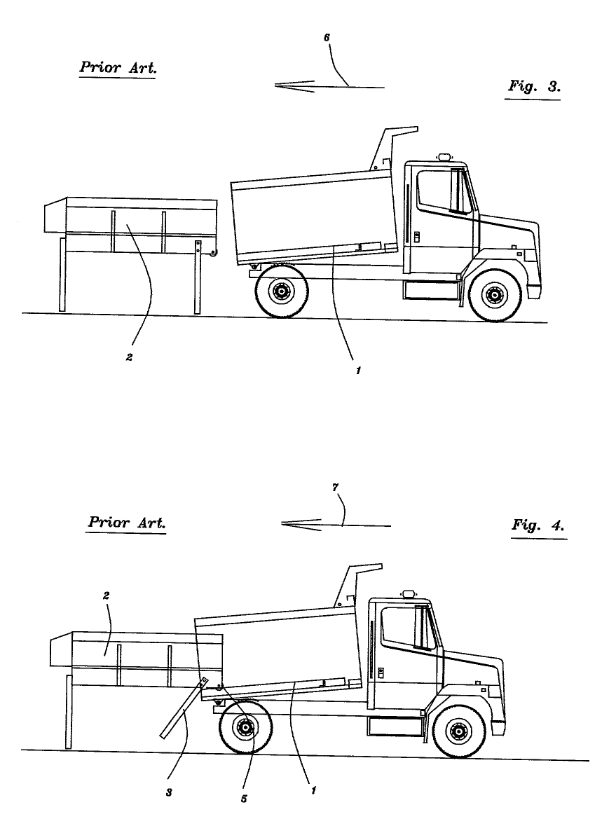

FIG. 2 is a similar view to that shown in FIG. 1 but shows the truck body floor 1 slightly raised.

FIG. 3 is a similar view to that shown in FIG. 2 but shows the truck being reversed as indicated by the arrow 6 towards the load 2.

FIG. 4 is a similar view to that shown in FIG. 3 but shows the truck being further reversed as indicated by the arrow 7 so that the rollers 5 engage the rear end of the raised floor 1 of truck body and so that the front legs 3 begin to fold.

FIG. 5 is a similar view to that shown in FIG. 4 but shows the truck having been yet further reversed as indicated by the arrow 8 and the front legs 3 folded and the rear end of the load 2 still being supported by the rear legs 4.

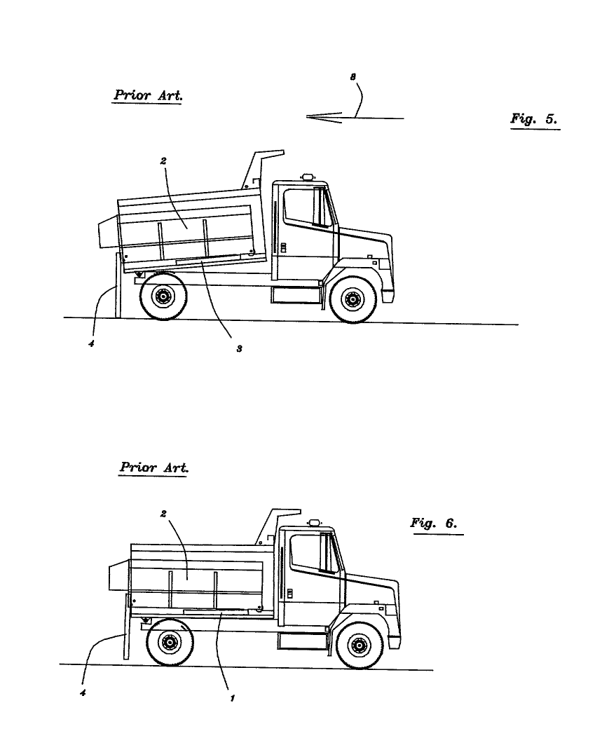

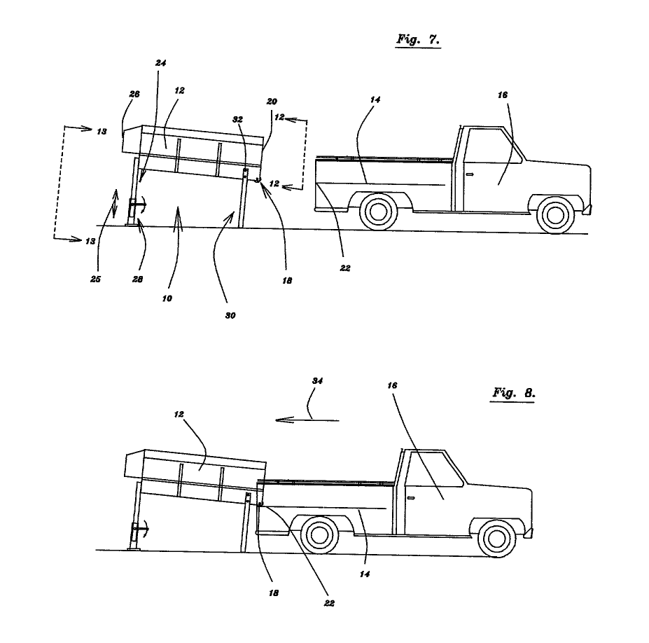

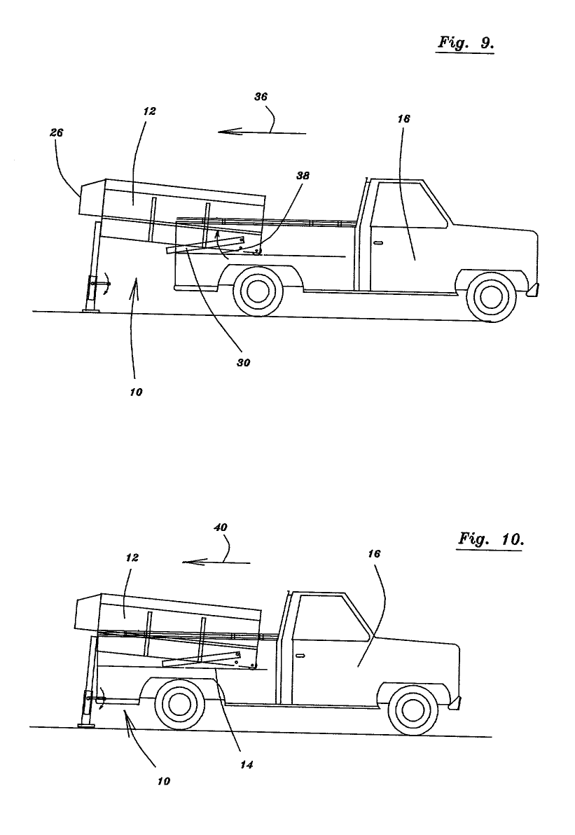

FIG. 6 is a similar view to that shown in FIG. 5 but shows the truck body floor 1 lowered so that the weight of the load 2 is being supported on the truck body floor 1 and the rear legs 4 coming out of contact with the road surface.

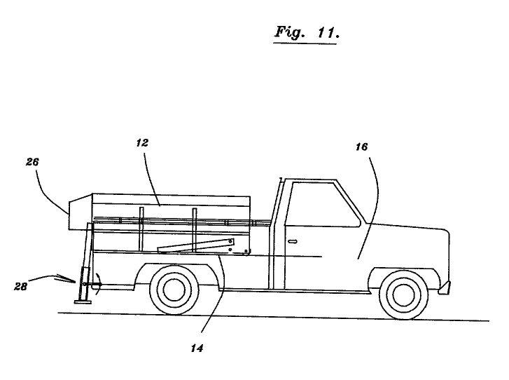

FIG. 7 is a side elevational view of a loading device generally designated 10 according to the present invention. As shown in FIG. 7 the loading device 10 is provided for loading and unloading a load 12 such as a sand and gravel spreader relative to a horizontally disposed bed 14 of a truck 16. The device 10 includes a gliding arrangement generally designated 18 secured to a first end 20 of the load 12. The gliding arrangement 18 engages a rear end 22 of the bed 14 of the truck 16 when the truck 16 is reversed towards the gliding arrangement 18. A leg generally designated 24 is secured to a second end 26 of the load 12 such that the load 12 is disposed substantially between the gliding arrangement 18 and the leg 24. A lifting mechanism generally designated 28 is secured to the leg 24 for selectively lifting and lowering the leg 24, as indicated by the arrow 25. Additionally, a support generally designated 30 is pivotally secured at 32 to the load 12 between the gliding arrangement 18 and the leg 24. The arrangement is such that in a first disposition of the device 10 as shown in FIG. 7, the lifting mechanism 28 is adjusted to a lifted mode so that the leg 24 is lifted such that the second end 26 of the load 12 is disposed higher than the first end 20 of the load 12.

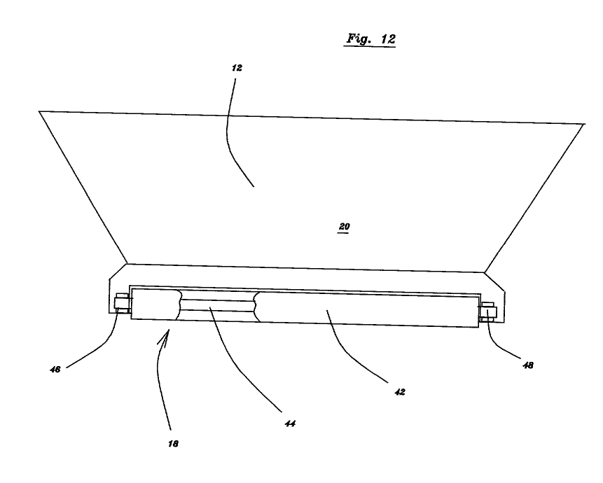

FIG. 8 is a view which is similar to that shown in FIG. 7 but shows the truck 16 being reversed as indicated by the arrow 34 towards the gliding arrangement 18. As shown in FIG. 8, the gliding arrangement 18 engages the rear end 22 of the bed 14 of the truck 16.

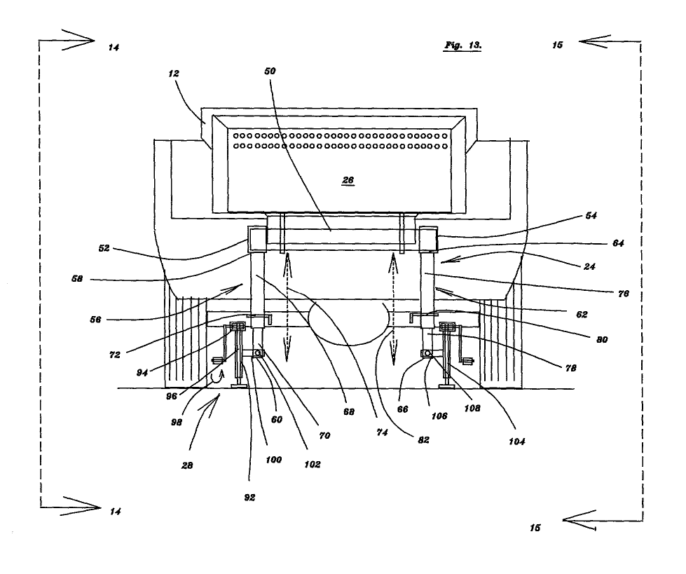

FIG. 9 is a view which is similar to that shown in FIG. 8 but shows the truck 16 having been further reversed as indicated by the arrow 36 towards the second end 26 of the load 12. As shown in FIG. 9, in a second disposition of the device 10, when the truck 16 is further reversed towards the second end 26 of the load 12, the support 30 pivots as indicated by the arrow 38 towards the load 12 due to contact of the support 30 with the truck 16.

FIG. 10 is a view which is similar to that shown in FIG. 9 but shows a third disposition of the device 10. As shown in FIG. 10, when the truck 16 has been yet further reversed as indicated by the arrow 40, the load 12 is disposed above the bed 14 of the truck 16.

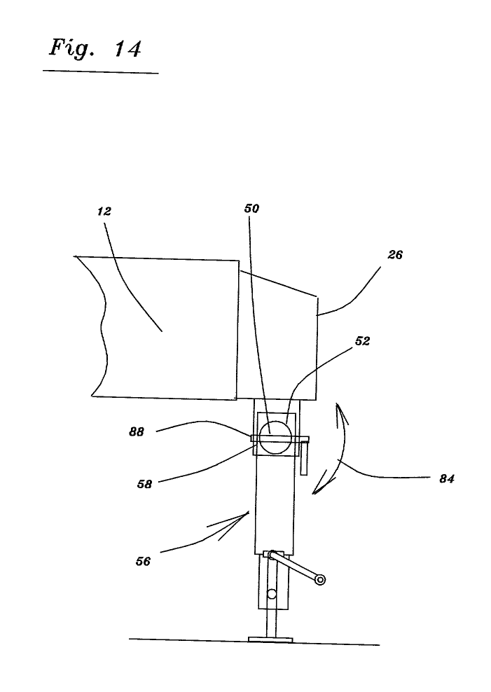

FIG. 11 is a view which is similar to that shown in FIG. 10 but shows the lifting mechanism 28 adjusted to a lowered mode. As shown in FIG. 11, the lifting mechanism 28 is adjusted to the lowered mode such that the second end 26 of the load 12 is supported on the bed 14 of the truck 16.

FIG. 12 is an enlarged view taken on the line 12-12 of FIG. 7. As shown in FIG. 12, the gliding arrangement 18 includes a roller 42 rotatably connected to the first end 20 of the load 12.

More particularly, the gliding arrangement 18 includes a shaft 44 having a first and a second extremity 46 and 48 respectively. The extremities 46 and 48 of the shaft 44 are bearingly supported by the first end 20 of the load 12 and the roller 42 is rotatably supported by the shaft 44.

FIG. 13 is an enlarged view taken on the line 13-13 of FIG. 7. As shown in FIG. 13, the leg 24 includes a transverse member 50 having a first and a second termination 52 and 54 respectively. The transverse member 50 is rigidly secured to the second end 26 of the load 12. A first strut generally designated 56 has a first and a second extremity 58 and 60 respectively, the first extremity 58 of the first strut 56 being connected to the first termination 52 of the transverse member 50. Also, a second strut generally designate 62 has a first and a second end 64 and 66 respectively, the first end 64 of the second strut 62 being connected to the second termination 54 of the transverse member 50.

Moreover, the first strut 56 includes a first portion 68 which is secured to the first termination 52 of the transverse member 50 and a second portion 70 is slidably connected to the first portion 68. A locking mechanism 72 is provided for locking the portions 68 and 70 together such that adjustment of a distance 74 between the first and second extremities 58 and 60 respectively of the first strut 56 is permitted.

Additionally, the second strut 62 includes a first arm 76 which is secured to the second termination 54 of the transverse member 50 and a second arm 78 is slidably connected to the first arm 76. A fastening mechanism 80 is provided for fastening the arms 76 and 78 together such that adjustment of a space 82 between the first and second ends 64 and 66 respectively of the second strut 62 is permitted.

FIG. 14 is a view taken on the line 14-14 of FIG. 13. As shown in FIG. 14, the first extremity 58 of the first strut 56 is rotatably secured to the first termination 52 of the transverse member 50 as indicated by the arrow 84.

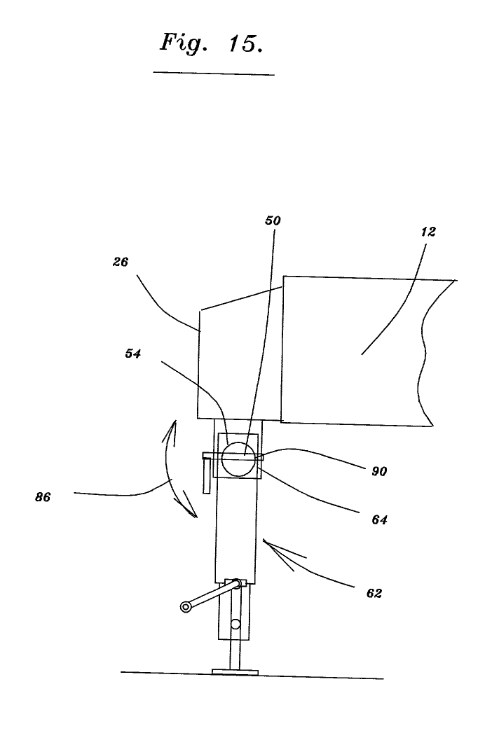

FIG. 15 is a view taken on the line 15-15 of FIG. 13. As shown in FIG. 15, the first end 64 of the second strut 62 is rotatably secured to the second termination 54 of the transverse member 50 as indicated by the arrow 86.

As shown in FIG. 14, an anchor 88 is included for selectively anchoring the first strut 56 in an operative disposition thereof as shown in FIG. 14.

As shown in FIG. 15, a further anchor 90 is provided for selectively anchoring the second strut 62 in an operative disposition thereof as shown in FIG. 15.

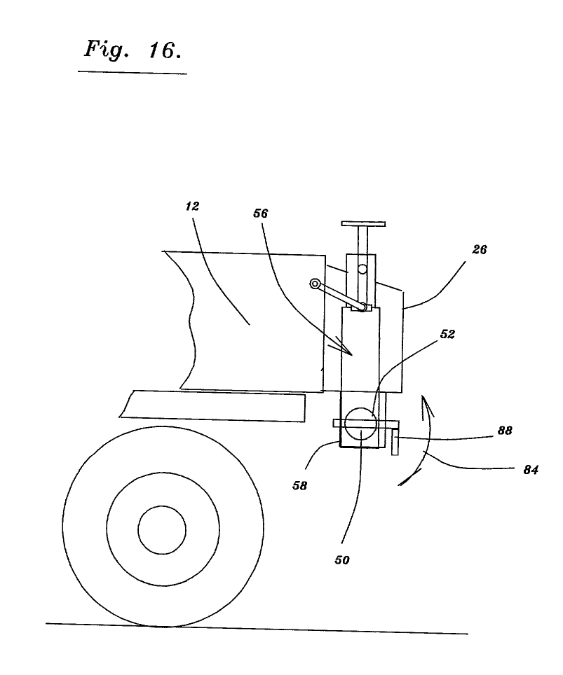

FIG. 16 is a similar view to that shown in FIG. 14 but shows the first strut 56 rotated to an inoperative disposition thereof.

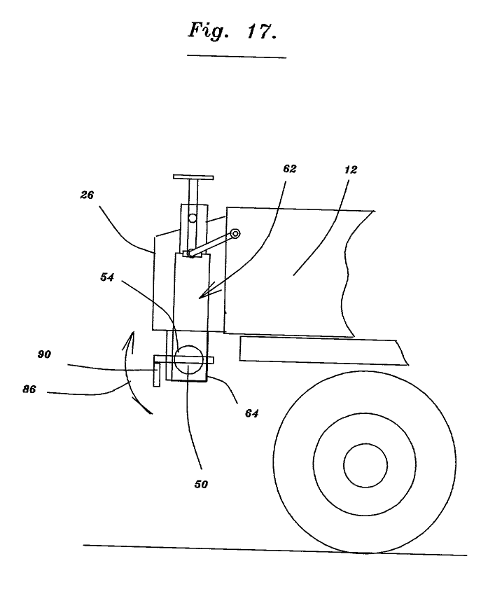

FIG. 17 is a similar view to that shown in FIG. 15 but shows the second strut 62 rotated to an inoperative disposition thereof.

Additionally, as shown in FIG. 13 the lifting mechanism 28 includes a jack 92.

In the embodiment of the present invention shown in FIG. 13, the jack 92 includes a rotatable rod 94 and a member 96 threadably cooperating with the rod 94 such that when the rod 94 is rotated as indicated by the arrow 98, the lifting mechanism 28 is moved between the lifted mode as shown in FIGS. 7-10 and the lowered mode as shown in FIG. 11.

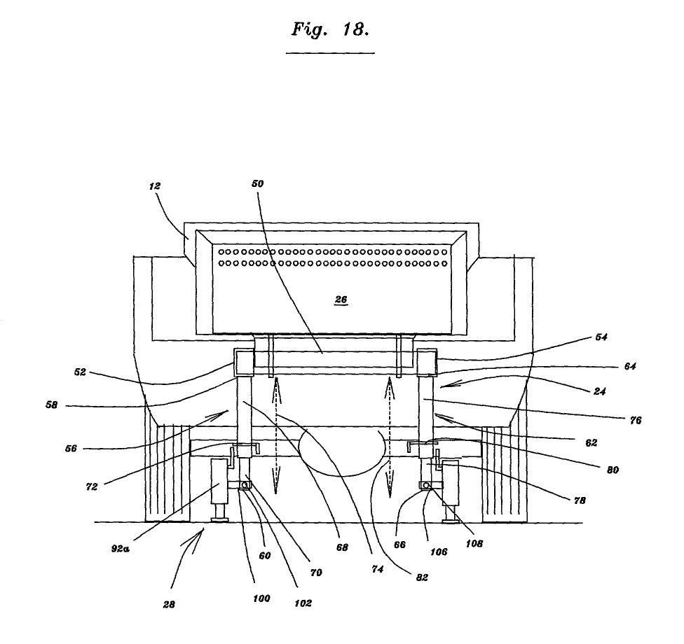

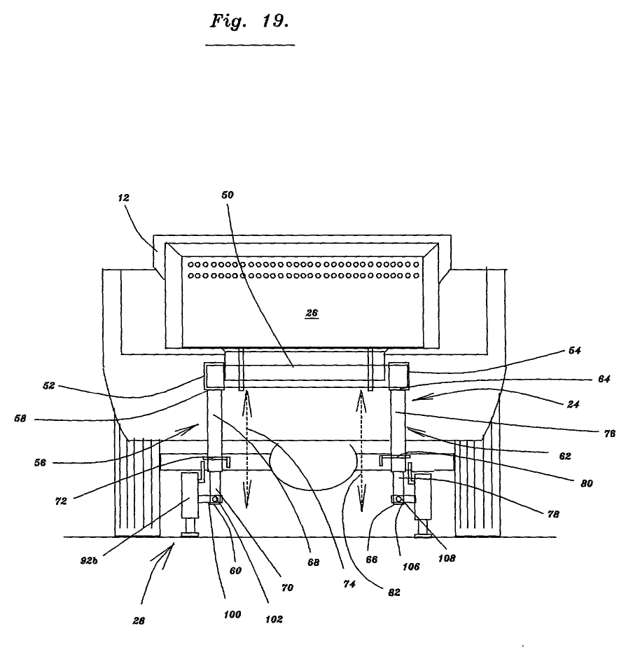

FIG. 18 shows a second embodiment of the present invention. As shown in FIG. 18, a jack 92a is hydraulically operated.

FIG. 19 shows a third embodiment of the present invention. As shown in FIG. 19, a jack 92b is electrically operated.

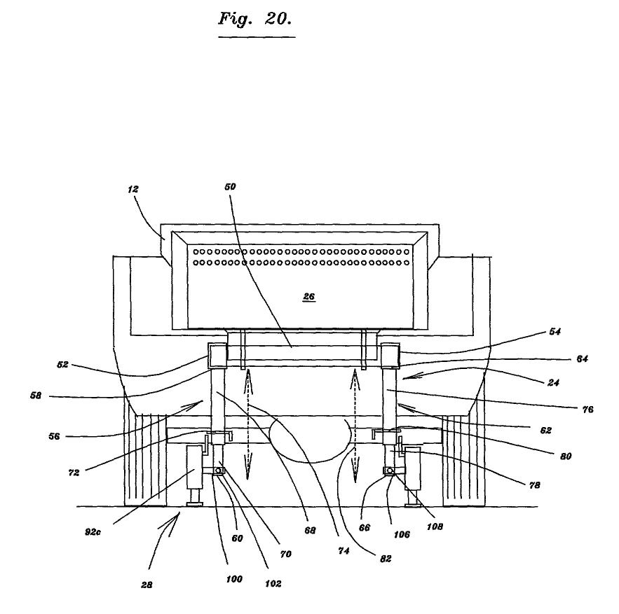

FIG. 20 shows a fourth embodiment of the present invention. As shown in FIG. 20, a jack 92c is pneumatically operated.

In a preferred embodiment of the present invention, as shown in FIG. 13, the lifting mechanism 28 includes a first jack 92 which is rotatably secured at 100 to the second portion 70. A pin 102 is provided for selectively locking the first jack 92 in an operative disposition thereof as shown in FIGS. 7-11 and for locking the first jack 92 in an inoperative disposition thereof. A second jack 104 is rotatably secured at 106 to the second arm 78 and a further pin 108 is included for selectively locking the second jack 104 in an operative disposition thereof as shown in FIGS. 7-11 and for locking the second jack 104 in an inoperative disposition thereof.

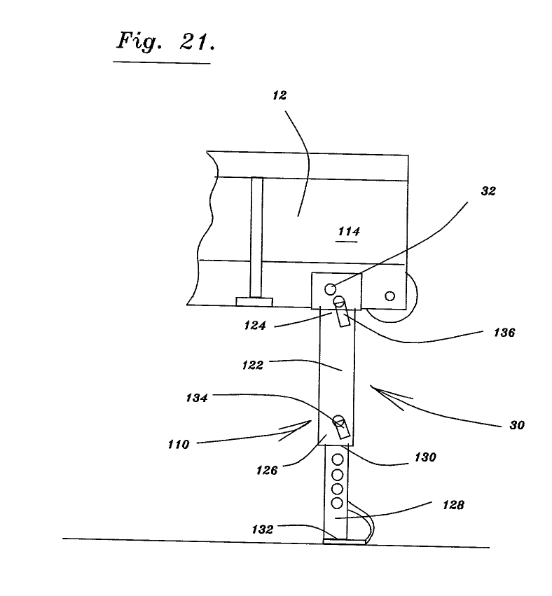

FIG. 21 is an enlarged side elevational view of the support shown in FIG. 7. As shown in FIG. 21 the support 30 includes a first brace generally designated 110 which is pivotally connected at 32 to a first side 114 of the load 12.

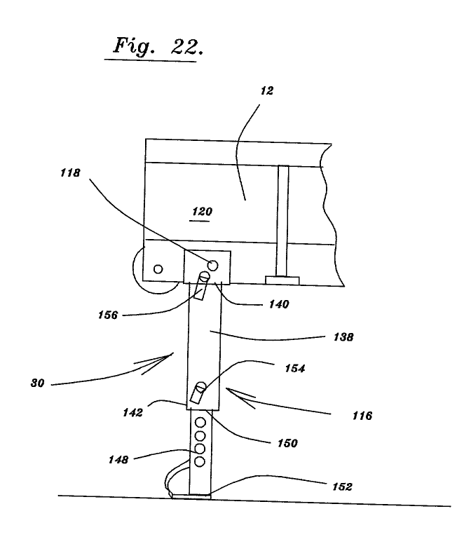

FIG. 22 is a view of the support 30 shown in FIG. 7 but viewed from the opposite side. As shown in FIG. 22, a second brace generally designated 116 is pivotally connected at 118 to a second side 120 of the load 12.

More specifically, as shown in FIG. 21, the first brace 110 include s a first member 122 having a first and a second end 124 and 126 respectively, the first end 124 being pivotally connected at 32 to the first side 114 of the load 12. A second member 128 has a first and a second extremity 130 and 132 respectively. The first extremity 130 of the second member 128 slidably cooperates with the second end 126 of the first member 122. A lock 134 is provided for adjustably locking the first member 122 relative to the second member 128. A further lock 136 is included for locking the first end 124 of the first member 122 relative to the load 12 when the load 12 is to be supported in the absence of the truck 16.

Furthermore, as shown in FIG. 22, the second brace 116 includes a third member 138 which has a first and a second end 140 and 142 respectively. The first end 140 is pivotally connected at 118 to the second side 120 of the load 12. Also, a fourth member 148 has a first and a second extremity 150 and 152 respectively. The first extremity 150 of the fourth member 148 slidably cooperates with the second end 142 of the third member 138. A locking device 154 is provided for adjustably locking the third member 138 relative to the fourth member 148. A further locking device 156 is included for locking the first end 140 of the third member 138 relative to the load 12 when the load 12 is to be supported in the absence of the truck 16.

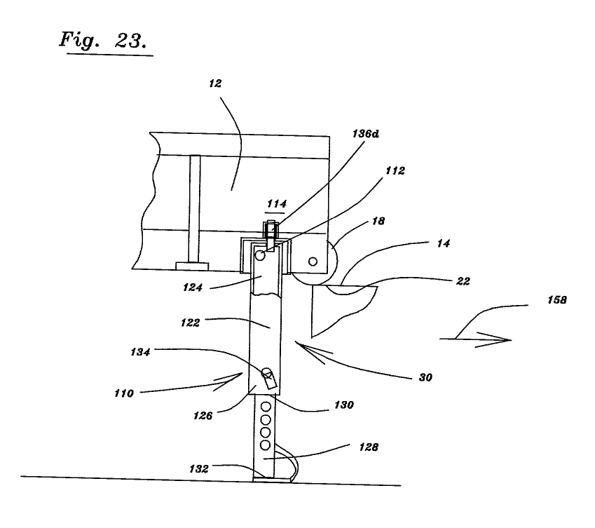

FIG. 23 is a view of a further embodiment of the present invention in which the further lock is a self locking lock. As shown in FIG. 23 the further lock 136d is a self locking lock such that during an unloading operation, when the truck 16 is driven forward as indicated by the arrow 158 with the lifting mechanism 28 disposed in the lifted mode and when the gliding arrangement 18 glides along the bed 14 of the truck 16 towards the rear end 22 thereof and when the first brace 110 pivots to a supporting disposition thereof, the further lock 136d automatically engages an orifice in the member 122 and locks therein so that in the absence of the truck 16, the load 12 is supported by the first and second brace 110 and 116 respectively and the leg 24.

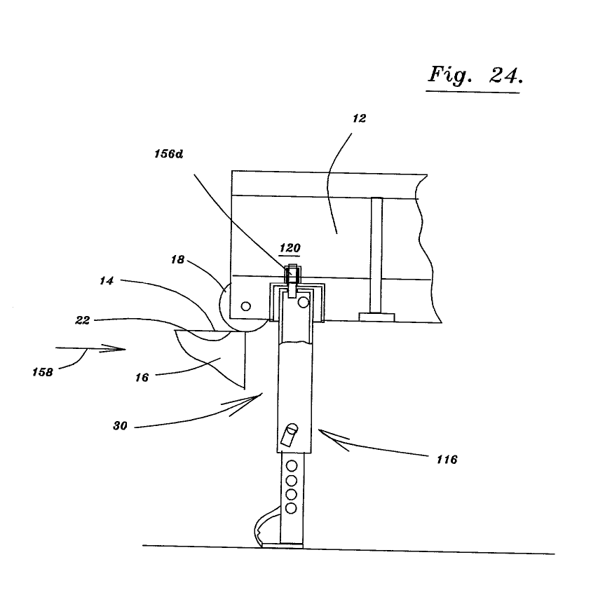

FIG. 24 is a view of the further embodiment shown in FIG. 23 but viewed from the opposite side. As shown in FIG. 24, a further locking device 156d is a self locking lock such that during the unloading operation, when the truck 16 is driven forward as indicated by the arrow 158 with the lifting mechanism 28 disposed in the lifted mode and when the gliding arrangement 18 glides along the bed 14 of the truck 16 towards the rear end 22 thereof and when the second brace 116 pivots to a supporting disposition thereof, the further locking device 156d automatically engages a further orifice in the member 138 and locks therein so that in the absence of the truck 16, the load 12 is supported by the first and second brace 110 and 116 respectively and the leg 24.

In the embodiments of the present invention as shown in FIGS. 7-24, the first and second brace 110 and 116 respectively pivot between a stowed disposition and a supporting disposition thereof by gravity.

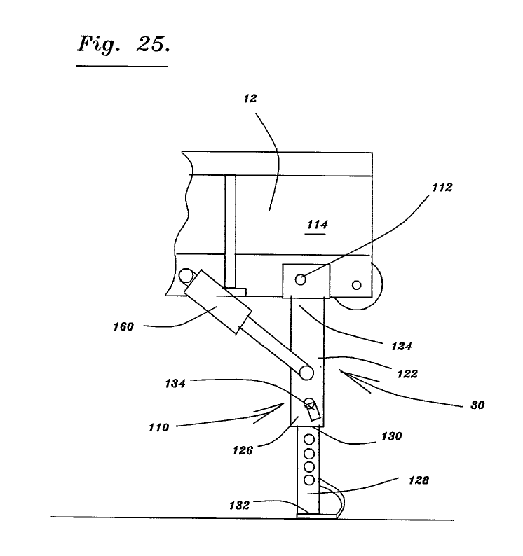

FIG. 25 shows another embodiment of the present invention. As shown in FIG. 25, a drive is provided for driving the support 30. The drive 160 is provided for pivoting the first and second brace 110 and 116 respectively such that the first and second brace 110 and 116 respectively are pivotally driven by the drive 160 between a stowed disposition and a supporting disposition thereof.

In operation of the device, the truck 16 is reversed towards the load 12 and the roller engages the rear end 22 of the bed 14 of the truck. Further reversing causes the load to roll onto the bed 14 so that the support 30 is pivoted to the folded disposition. As the truck is reversed, the load 12 becomes located above the bed 14. The jacks are then adjusted to lower the load until the load 12 is completely supported by the bed 14. The struts 56 and 62 are then rotated 180 degrees and locked in place for transportation.

The unloading operation involves the opposite steps. The first step involves rotating the struts 56 and 62 and locking the same in place. The jacks are then adjusted to lift the rear end of the load from the bed 14 so that when the truck is moved forward, the roller 42 glides along the bed 14 until the support has swung down to the supporting vertical disposition thereof. When the support has been locked, the truck is further moved forward so that the load is supported on the support 30 and the leg 24.

The present invention provides a unique and relatively simple means for loading and unloading heavy equipment onto a truck having a fixed non hoistable bed.

What is claimed is:

1. A loading device for loading and unloading a load relative to a horizontally disposed bed of a truck, said device comprising:
a gliding arrangement secured to a first end of the load, said gliding arrangement engaging a rear end of the bed of the truck when the truck is reversed towards the gliding arrangement;
a leg secured to a second end of the load such that the load is disposed substantially between said gliding arrangement and said leg;
a lifting mechanism secured to said leg for selectively lifting and lowering said leg; and
a support pivotally secured to the load between said gliding arrangement and said leg, the arrangement being such that in a first disposition of the device, when said lifting mechanism is adjusted to a lifted mode so that said leg is lifted such that the second end of the load is disposed higher than the first end of the load, the truck is reversed towards said gliding arrangement such that said gliding arrangement engages the rear end of the bed of the truck and such that in a second disposition of the device, when the truck is further reversed towards the second end of the load, said support pivots towards the load due to contact of said support with the truck and such that in a third disposition of the device, when the truck has been yet further reversed so that the load is disposed above the bed of the truck, said lifting mechanism is adjusted to a lowered mode such that the second end of the load is supported on the bed of the truck.

2. A loading device as set forth in claim 1 wherein
said gliding arrangement includes:
a roller rotatably connected to said first end of the load.

3. A loading device as set forth in claim 2 wherein
said gliding arrangement includes:
a shaft having a first and a second extremity, said extremities of said shaft being bearingly supported by the first end of the load;
said roller being rotatably supported by said shaft.

4. A loading device as set forth in claim 1 wherein
said leg includes:
a transverse member having a first and a second termination, said transverse member being rigidly secured to the second end of the load;
a first strut having a first and a second extremity, said first extremity of said first strut being connected to said first termination of said transverse member;
a second strut having a first and a second end, said first end of said second strut being connected to said second termination of said transverse member.

5. A loading device as set forth in claim 4 wherein
said first strut includes:
a first portion secured to said first termination of said transverse member;
a second portion slidably connected to said first portion;
a locking mechanism for locking said portions together such that adjustment of a distance between said first and second extremities of said first strut is permitted;
said second strut includes:
a first arm secured to said second termination of said transverse member;
a second arm slidably connected to said first arm;
a fastening mechanism for fastening said arms together such that adjustment of a space between said first and second ends of said second strut is permitted.

6. A loading device as set forth in claim 4 wherein
said first extremity of said first strut is rotatably secured to said first termination of said transverse member;
said first end of said second strut is rotatably secured to said second termination of said transverse member;
an anchor for selectively anchoring said first strut in an operative disposition thereof and an inoperative disposition thereof;
a further anchor for selectively anchoring said second strut in an operative disposition thereof and an inoperative disposition thereof.

7. A loading device as set forth in claim 1 wherein
said lifting mechanism includes:
a jack.

8. A loading device as set forth in claim 7 wherein
said jack includes:
a rotatable rod;
a member threadably cooperating with said rod such that when said rod is rotated, said lifting mechanism is moved between said lifted mode and said lowered mode.

9. A loading device as set forth in claim 7 wherein
said jack is hydraulically operated.

10. A loading device as set forth in claim 7 wherein
said jack is electrically operated.

11. A loading device as set forth in claim 7 wherein
said jack is pneumatically operated.

12. A loading device as set forth in claim 5 wherein
said lifting mechanism includes:
a first jack rotatably secured to said second portion;
a pin for selectively locking said first jack in an operative disposition thereof and for locking said first jack in an inoperative disposition thereof;
a second jack rotatably secured to said second arm;
a further pin for selectively locking said second jack in an operative disposition thereof and for locking said second jack in an inoperative disposition thereof;

13. A loading device as set forth in claim 1 wherein
said support includes:
first brace pivotally connected to a first side of the load;
a second brace pivotally connected to a second side of the load.

14. A loading device as set forth in claim 13 wherein
said first brace includes:
a first member having a first and a second end, said first end being pivotally connected to the first side of the load;
a second member having a first and a second extremity, said first extremity of said second member slidably cooperating with said second end of said first member;
a lock for adjustably locking said first member relative to said second member;
a further lock for locking said first end of said first member relative to the load when the load is to be supported in an absence of the truck;
said second brace includes:
a third member having a first and a second end, said first end being pivotally connected to the second side of the load;
a fourth member having a first and a second extremity, said first extremity of said fourth member slidably cooperating with said second end of said third member;
a locking device for adjustably locking said third member relative to said fourth member;
a further locking device for locking said first end of said third member relative to the load when the load is to be supported in the absence of the truck.

15. A loading device as set forth in claim 14 wherein
said further lock is a self locking lock such that during an unloading operation, when the truck is driven forward with said lifting mechanism disposed in said lifted mode, said gliding arrangement glides along the bed of the truck towards the rear end thereof and said first brace pivots to a supporting disposition thereof, said further lock automatically locks so that in the absence of the truck, the load is supported by said first and second brace and said leg;
said further locking device is a self locking lock such that during an unloading operation, when the truck is driven forward with said lifting mechanism disposed in said lifted mode, said gliding arrangement glides along the bed of the truck towards the rear end thereof and said second brace pivots to a supporting disposition thereof, said further locking device automatically locks so that in the absence of the truck, the load is supported by said first and second brace and said leg.

16. A loading device as set forth in claim 13 wherein
said first and second brace pivot between a stowed disposition and a supporting disposition thereof by gravity.

17. A loading device as set forth in claim 13 further including:
a drive for pivoting said first and second brace such that said first and second brace are pivotally driven by said drive between a stowed disposition and a supporting disposition thereof.

18. A loading device for loading and unloading a load relative to a horizontally disposed bed of a truck, said device comprising:
a gliding arrangement secured to a first end of the load, said gliding arrangement engaging a rear end of the bed of the truck when the truck is reversed towards the gliding arrangement;
a leg secured to a second end of the load such that the load is disposed substantially between said gliding arrangement and said leg;
a lifting mechanism secured to said leg for selectively lifting and lowering said leg;
a support pivotally secured to the load between said gliding arrangement and said leg, the arrangement being such that in a first disposition of the device, when said lifting mechanism is adjusted to a lifted mode so that said leg is lifted such that the second end of the load is disposed higher than the first end of the load, the truck is reversed towards said gliding arrangement such that said gliding arrangement engages the rear end of the bed of the truck and such that in a second disposition of the device, when the truck is further reversed towards the second end of the load, said support pivots towards the load due to contact of said support with the truck and such that in a third disposition of the device, when the truck has been yet further reversed so that the load is disposed above the bed of the truck, said lifting mechanism is adjusted to a lowered mode such that the second end of the load is supported on the bed of the truck; and
said lifting mechanism including:
a jack.

19. A loading device for loading and unloading a load relative to a horizontally disposed bed of a truck, said device comprising:
a gliding arrangement secured to a first end of the load, said gliding arrangement engaging a rear end of the bed of the truck when the truck is reversed towards the gliding arrangement;
a leg secured to a second end of the load such that the load is disposed substantially between said gliding arrangement and said leg;
a lifting mechanism secured to said leg for selectively lifting and lowering said leg;
a support pivotally secured to the load between said gliding arrangement and said leg, the arrangement being such that in a first disposition of the device, when said lifting mechanism is adjusted to a lifted mode so that said leg is lifted such that the second end of the load is disposed higher than the first end of the load, the truck is reversed towards said gliding arrangement such that said gliding arrangement engages the rear end of the bed of the truck and such that in a second disposition of the device, when the truck is further reversed towards the second end of the load, said support pivots towards the load due to contact of said support with the truck and such that in a third disposition of the device, when the truck has been yet further reversed so that the load is disposed above the bed of the truck, said lifting mechanism is adjusted to a lowered mode such that the second end of the load is supported on the bed of the truck;
said gliding arrangement including:
a roller rotatably connected to said first end of the load;
shaft having a first and a second extremity, said extremities of said shaft being bearingly supported by the first end of the load;
said roller being rotatably supported by said shaft;
said leg including:
a transverse member having a first and a second termination, said transverse member being rigidly secured to the second end of the load;
a first strut having a first and a second extremity, said first extremity of said first strut being connected to said first termination of said transverse member;
a second strut having a first and a second end, said first end of said second strut being connected to said second termination of said transverse member;
said first strut including:
a first portion secured to said first termination of said transverse member;
a second portion slidably connected to said first portion;
a locking mechanism for locking said portions together such that adjustment of a distance between said first and second extremities of said first strut is permitted;
said second strut including:
first arm secured to said second termination of said transverse member;
second arm slidably connected to said first arm;
a fastening mechanism for fastening said arms together such that adjustment of a space between said first and second ends of said second strut is permitted;
said first extremity of said first strut being rotatably secured to said first termination of said transverse member;
said first end of said second strut being rotatably secured to said second termination of said transverse member;
an anchor for selectively anchoring said first strut in an operative disposition thereof and an inoperative disposition thereof;
a further anchor for selectively anchoring said second strut in an operative disposition thereof and an inoperative disposition thereof;
said lifting mechanism including:
a first jack rotatably secured to said second portion;
a pin for selectively locking said first jack in an operative disposition thereof and for locking said first jack in an inoperative disposition thereof;
a second jack rotatably secured to said second arm;
a further pin for selectively locking said second jack in an operative disposition thereof and for locking said second jack in an inoperative disposition thereof;
said support including:
a first brace pivotally connected to a first side of the load;
a second brace pivotally connected to a second side of the load;
said first brace including:
a first member having a first and a second end, said first end being pivotally connected to the first side of the load;
a second member having a first and a second extremity, said first extremity of said second member slidably cooperating with said second end of said first member;
a lock for adjustably locking said first member relative to said second member;
a further lock for locking said first end of said first member relative to the load when the load is to be supported in an absence of the truck;
said second brace including:
a third member having a first and a second end, said first end being pivotally connected to the second side of the load;
a fourth member having a first and a second extremity, said first extremity of said fourth member slidably cooperating with said second end of said third member;
a locking device for adjustably locking said third member relative to said fourth member;
a further locking device for locking said first end of said third member relative to the load when the load is to be supported in the absence of the truck; and
said first and second brace pivoting between a stowed disposition and a supporting disposition thereof by gravity.
